(19) United States
(12) Patent Application Publication
(10) Pub. No.: US 2011/0296081 A1
(43) Pub. Date: Dec. 1, 2011

(54) DATA ACCESSING METHOD AND RELATED CONTROL SYSTEM

(76) Inventors: Chia-Jung Hsu, Taipei City (TW); Lian-Chun Lee, Hsinchu County (TW); Kun-Pin Lai, Hsin-Chu City (TW)

(21) Appl. No.: 12/875,120

(22) Filed: Sep. 2, 2010

(30) Foreign Application Priority Data
May 28, 2010 (TW) 099117193

(51) Int. Cl. G06F 12/00; G06F 12/02

(52) U.S. Cl. 711/103; 711/154; 711/E12.001; 711/E12.008

(57) ABSTRACT

A data access method and a related control system are provided according to embodiments of the present invention, which enhances the read/write performance of a data storage unit by performing pre-accessing operations upon the data storage unit. The data access method includes receiving a plurality of access requests and a plurality of corresponding addresses to access a plurality of data corresponding to the plurality of access requests from a storage unit; and performing a pre-accessing operation upon the storage unit according to the uniformity of the plurality of access requests and the continuity between the plurality of addresses.

### BACKGROUND OF THE INVENTION

1. Field of the Invention

The present invention relates to data accessing, and more particularly, to a data access method and a related control system which improves the read/write performance of a storage unit by performing speculatively pre-accessing operations.

2. Description of the Prior Art

In general, a relationship between an operating system/a high-level application program and hardware apparatus (e.g. a control circuit of a storage unit) can be simply illustrated with FIG. 1. As shown in FIG. 1, an operating system 110 employs a driver (or a firmware) 120 to communicate with/to command the control circuit 130. For example, the operating system 110 may utilize the driver 120 to command the control circuit 130 to access a storage unit (not shown). The process regarding a conventional data access method is summarized in a flow chart shown in FIG. 2. In particular, FIG. 2 shows steps regarding two successive data access operations. Firstly, in step 201, the operating system/the high-level application program issues an access request, and when the driver receives the access request, the driver issues a command to a control circuit of a storage unit (step 202). Accordingly, the control circuit performs a data access operation upon the storage unit (step 203) based on the command and a corresponding memory address (indicating some specific space in the storage unit). Subsequently, the read data will be sent to an address assigned by the operating system or the data will be written into the storage unit. In step 204, the control circuit sends a complete interrupt (Complete INT) after the command is completed. When the driver notices the complete INT and acknowledges the source of the complete INT, the driver will return the request acknowledged message (REQ_ACK) to the operating system (step 205). After the operating system receives the REQ_ACK, the operating system issues a next access request. Again, similar operations will be executed in a same order for data access (step 206-210). In fact, the control circuit has already done all the operations in step 204. However, the control circuit has to wait for the operating system to issue the next access request and wait for the driver to accordingly issue the command to the control circuit (step 206) in order to perform a next data access operation upon the storage unit. Thus, between two successive data access operation, the control circuit and the storage unit are idle for a quite long period of time (step 204-206). There are some defects in the conventional data access method need to be ameliorated.

### SUMMARY OF THE INVENTION

With this in mind, the present invention provides a data access method and a related control system which can perform speculatively pre-accessing operations in advance. This approach is achieved by observing the relationship of previous access requests, such as the uniformity of access direction (i.e. read or write) and the continuity between memory addresses to determine either to pre-reading the data corresponding to a specific address or to configure the storage unit to prepare for the oncoming writing operation corresponding to a specific address before a next access request is received. According to this, the idle time caused by the control circuit and the storage units waiting for the response of the operation system (e.g. steps 204-206) can be greatly reduced so as to improve the write/read performance of the control circuit and the storage unit.

According to one exemplary embodiment of the present invention, the inventive data access method comprises: receiving a plurality of access requests and a plurality of corresponding addresses to access a plurality of data corresponding to the access requests from a storage unit; and performing a pre-accessing operation upon the storage unit according to a uniformity of the access requests and a continuity between the addresses.

Furthermore, an inventive control system which is designed based on the exemplary embodiments of the present invention comprises a control circuit and a determination module. The control circuit is employed for accessing a storage unit. The determination module is coupled to the control circuit and employed for receiving a plurality of access requests and a plurality of corresponding addresses to command the control circuit to access a plurality of data corresponding to the access requests from a storage unit and according to a uniformity of the access requests and the continuity between the addresses, to command the control circuit to perform a speculatively pre-accessing operation upon the storage unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram showing conventional data access architecture.

FIG. 2 is a flow chart showing a conventional data access method.

FIG. 3 is a generalized flow chart showing an inventive data access method according to an exemplary embodiment of the present invention.

FIG. 4 is a block diagram showing an inventive control system according to an exemplary embodiment of the present invention.

FIGS. 5A and 5B illustrate a detailed flow chart showing an inventive data access method according to an exemplary embodiment of the present invention.

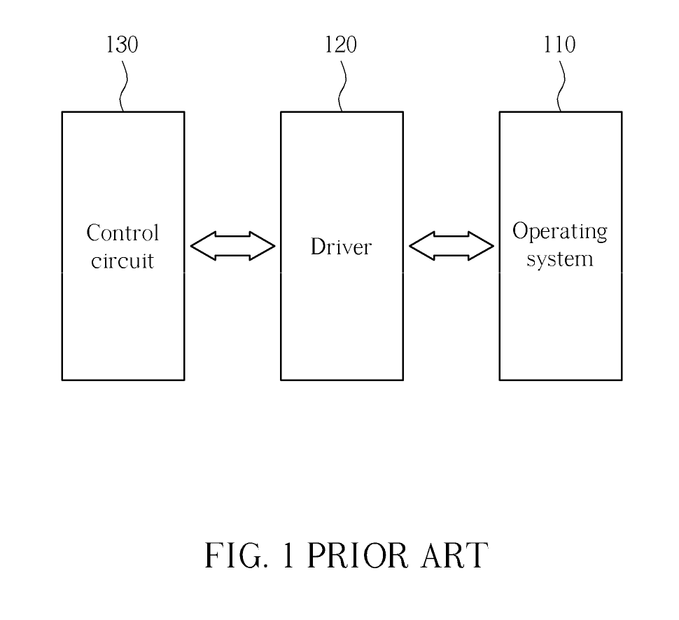

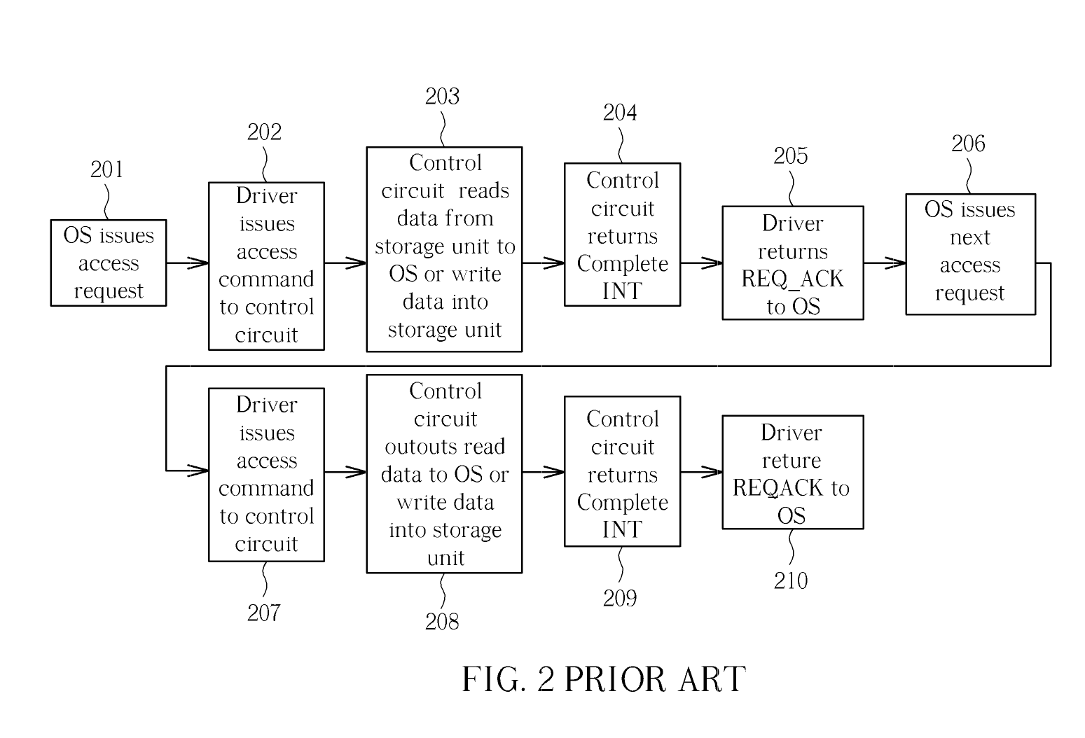

### DETAILED DESCRIPTION

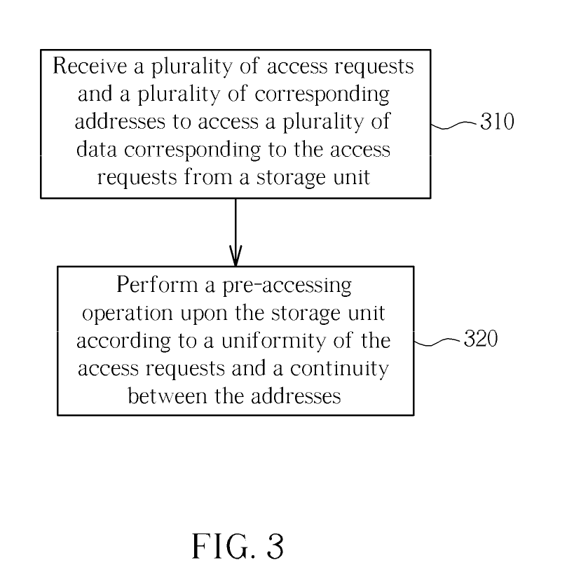

Please refer to FIG. 3, which illustrates a generalized flow chart of the inventive data access method according to one exemplary embodiment. In general, the inventive data access method includes step 310 and step 320. In step 310, the inventive data access method receives a plurality of access requests issued by an operating system and a plurality of corresponding memory addresses to perform a plurality of data access operations upon a storage unit (e.g. a flash memory). The plurality of data access operations respectively corresponds to the plurality of access requests and the plurality of memory addresses. In step 320, the inventive data access method performs a speculatively pre-accessing operation according to the uniformity of the plurality of access requests and the continuity between the memory addresses.

For example, if the plurality of access requests issued by the operating system includes four access requests and all the access requests are read requests which respectively correspond to memory addresses: addresses [0-3], addresses [4-7], addresses [8-11] and addresses [12-15]. According to this, the inventive data access method issues data access command to perform a speculatively pre-accessing operation upon the storage unit, wherein the speculatively pre-accessing operation is to perform a read operation upon the storage unit with respect to addresses [12-15]. Then, if a further access request issued by the operating system is received, the inventive data access method determines the relationship between the further access request and the pre-accessing operation. For example, if the further access request is to read data stored in addresses [12-13], the inventive data access method directly outputs the pre-read data derived by the pre-accessing operation. In particular, a part of the pre-read data corresponding to addresses [12-13] will be outputted. In should be note that the data amount derived by the pre-accessing operation is not limited in the invention, and the above-mentioned case is just for illustrative purpose. However, if the further access request is to read the data stored in addresses [12-17], the inventive data access method further reads data corresponds to addresses [16-17], and then simultaneously outputs the data corresponds to addresses [1-17] and addresses [12-15] to the operating system. Please note that the pre-accessing operation dose not predict the length of the data to be accessed; instead, the pre-accessing operation only predicts the access direction of possible access request in the following (i.e., read or write) and the possible memory address in the following. In addition, the case where the further access request corresponds to a same length of the data and the memory address with the pre-accessing operation is certainly included in the above-mentioned exemplary embodiment.

It should noted that the uniformity of the access directions of access requests is not limited as entirely uniform, and the continuity between the memory addresses is also not limited as entirely continuous. The inventive data access method may perform the speculatively pre-accessing operation when the uniformity of the access directions of access requests and the continuity between the memory addresses are regular to a certain extent. Beside, even though the access requests are illustrated as being issued by the operating system in the foregoing descriptions, it is, however, feasible that the access requests are issued by a high-level application program in other exemplary embodiments. Detailed descriptions about the inventive data access method will be given in the following with reference to various exemplary embodiments.

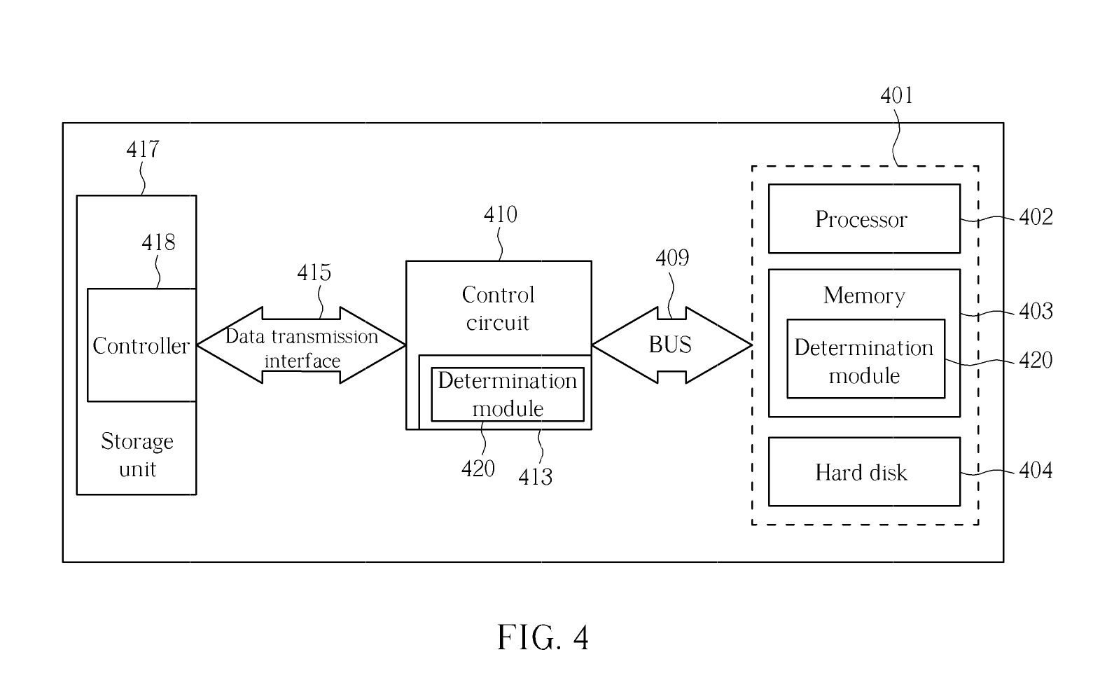

Based on the conception of the inventive data access method, the present invention further provides a related control system which is capable of performing a pre-accessing operation upon a storage unit, which is illustrated in FIG. 4 according to one exemplary embodiment of the present invention. The inventive control system mainly comprises a control circuit 410 and a determination module 420. The control circuit 410 performs data access operations upon a storage unit 417 (e.g. a memory card or a flash memory) through the data transmission interface 415. The control circuit 410 performs data accessing operations in accordance with commands issued by the determination module 420 (whose functions are similar to a driver), wherein the storage unit 417 also includes an internal controller 418 for controlling an operation of each memory cell of the storage unit 417. In different exemplary embodiments of the invention, the determination module 420 could be implemented in various ways. For example, the determination module 420 could be implemented with software program, which is loaded from a hard disk 404 of a host 401 to a memory 403 of the host 401, and executed by a processor 402 of the host 401. The processor executes the determination module 420 to issue a command to control the operation of the control circuit. However, the determination module 420 could be implemented with firmware program, which is embedded in a storage device 413 inside the control circuit 410 to issue command to the control circuit 410. Hence, the above-mentioned implementations both fall within the scope of the present invention. Access operations upon the storage unit 417 is mainly performed according to the access requests and memory addresses issued by an operation system (which is loaded into the memory 403 and executed by the processor 402) of the host 401. When the operation system issues an access request, the determination module 420 commands the control circuit to access the storage unit 417 according to the access request and a corresponding memory address.

As the present invention employs the determination module 420 to command the control circuit 419 to perform the speculatively data pre-accessing operation upon the storage unit 417, the determination module 420 observes the uniformity of write/read directions regarding access requests and the continuity between the corresponding memory addresses to determine whether to perform the speculatively data pre-accessing operation upon the storage unit 417. It should be noted that the above-mentioned write/read directions regarding the access requests may not be entirely identical and the memory addresses may not be entirely continuous. In some exemplary embodiments of the present invention, once the write/read directions regarding access requests and the memory addresses are regular to a certain extent, the determination module 420 will command the control circuit 410 to perform the pre-accessing operations upon the storage unit 417. Besides, even though the access requests are illustrated as being issued by the operating system in the foregoing descriptions, it is, however, feasible that the access requests are issued by a high-level application program in other exemplary embodiments.

In a preferred exemplary embodiments, when the determination module 420 ascertains all the access requests correspond to a same type of access operation (i.e., all read requests or all write requests), and the memory addresses are continuous, the determination module 420 determines a specific memory address which is continuous with the memory addresses, and commands the control circuit 410 to perform the pre-accessing operation according to the specific address. Furthermore, in the preferred exemplary embodiment, when the determination module 420 determines all the access requests are read requests, the determination module 420 commands the control circuit 410 to perform a read request according to the specific memory address to read a specific data with respect to the specific memory address. Accordingly, the control circuit 410 utilizes an internal buffer (e.g. a First in First out (FIFO) buffer) for temporarily storing the read specific data. Once the pre-accessing operation is completed, the determination module 420 subsequently determines whether the operating system issues a specific read request corresponding to the specific memory address. If the specific read request corresponding to the specific memory address is indeed received (e.g. the specific read request asks to read the data in the memory address which is the same as the memory address corresponding to the speculatively pre-read operation), the determination module 420 commands the control circuit 410 to directly output the temporarily stored data via the bus 409.

In the preferred exemplary embodiment, when the determination module 420 ascertains all the access requests are write requests, the determination module 420 commands the control circuit 410 to perform a write preparing operation to configure the storage unit 417 into a write ready state in advance. Once the write preparing operation is completed, the determination module 420 subsequently determines whether the operating system issues a specific write request corresponding to the specific memory address. If the determination module 420 determines the specific read request corresponding to the specific memory address is indeed received, (e.g. the specific write request asks to write the data to the memory address), the control circuit 410 receives a specific data corresponding to the specific write request via the bus 409, and according to the specific memory address, directly write the specific data into the storage unit 417 configured in the write ready state. In most cases, it possibly needs to cost significant time for erasing the stored data or for configuring the internal controller when the data is written into a storage unit composed of flash memories. Therefore, the present invention predicts the write requests, and issues the speculatively pre-writing requests to the storage unit 417 in advance before the operating system actually issues the write requests so that the internal controller of the storage unit 417 can prepare for the possible writing operations to enhance the write performance of the storage unit 417. In short, the present invention issues the command in advance to control the control unit 410 to perform write operations upon the storage unit 417 by predicting the possible write requests.

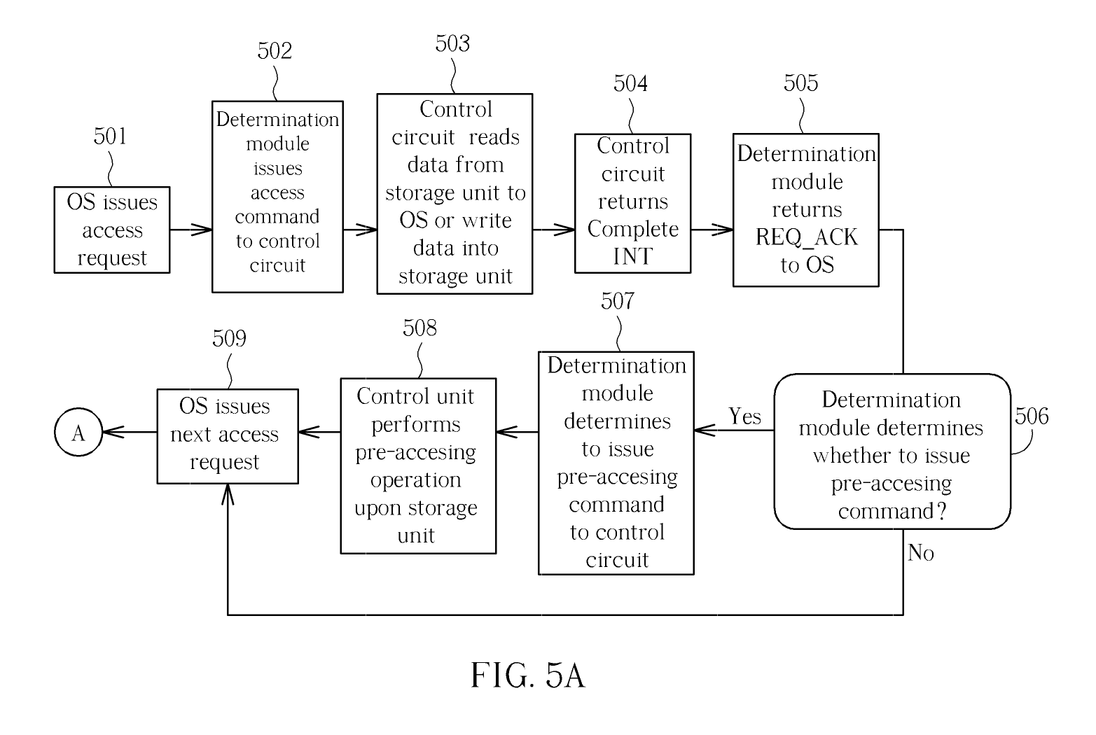

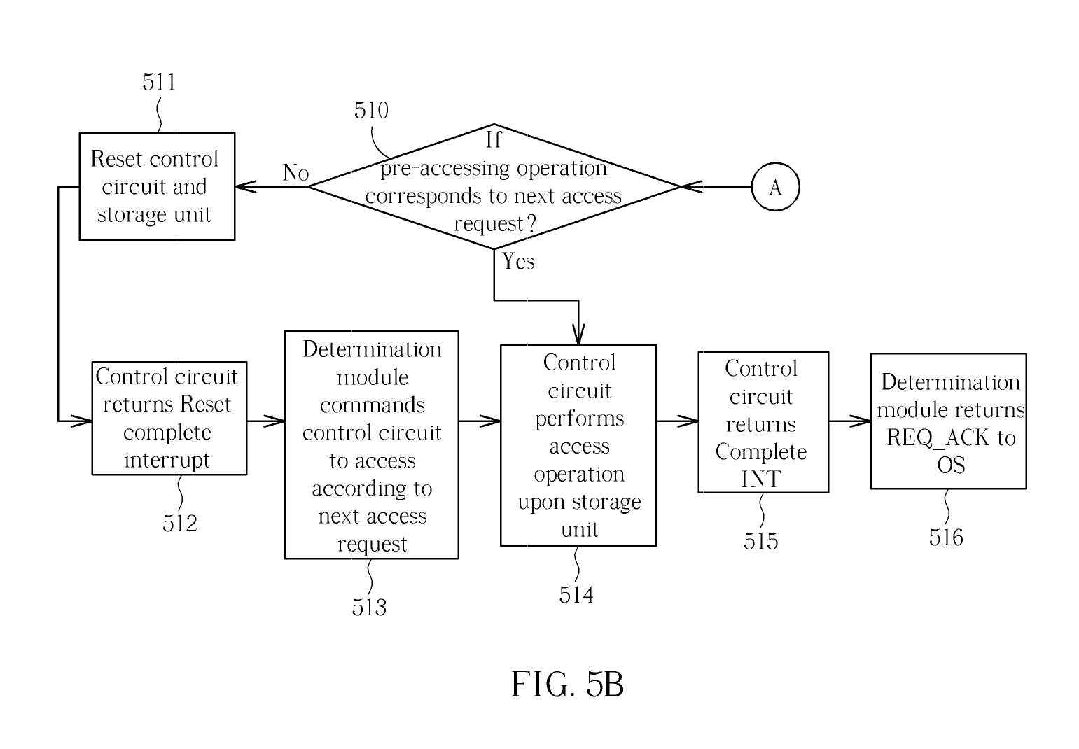

Referring to FIGS. 5A and 5B, a detailed flow chart of the inventive data accessing method according to one exemplary embodiment is illustrated. Operations of steps 501-505 are similar to the operations of steps 201-205, so the further descriptions thereof are omitted for the sake of clarity. It should be noted that before step 506 is entered, the operations of steps 501-505 must be executed more than once. Only doing so, the inventive data accessing method is able to determine whether to perform the pre-accessing method according to the uniformity of the plurality of access requests and the continuity between the plurality of memory addresses. Besides, the times of the steps 501-505 executed are not limited in the present invention. In step 506, the inventive determination module ascertains whether the access requests have the uniformity and the memory addresses have the continuity. If yes, step 507 is entered; otherwise, step 509 is entered, which waits for the operation system to issue a next access request. Once step 507 is entered, the determination module determines the access direction of a pre-accessing operation (that is, determines the pre-accessing operations is to read or to write) and a specific memory address corresponding to the pre-accessing operation, and accordingly issues the command to the control circuit to perform the pre-accessing operation upon the storage unit. In step 508, depending on that the pre-accessing operation is a pre-reading operation or a pre-writing accessing, the control circuit proceeds either to read the data in advance or to configure the storage unit in a write ready state in accordance with the specific memory address.

Then, when the operating system receives the REQ_ACK which is in response to the previous access request, the operating system accordingly issues a next access request in step 509. In step 510, the determination module determines whether the next access request issued by the operating system corresponds to the pre-accessing operation performed in step 508. If yes, step 514 is entered, in which the control circuit outputs the pre-read data to the operating system, or according to the specific memory address determined by the determination module, writes data into the storage unit configured in the write ready state. However, if the result of the determination in step 510 is no, step 511 will be entered, in which the determination module issues a command to reset the control circuit and the storage unit (e.g. flushes the temporarily stored pre-read data), and generates an interrupt indicating the completing of the reset in step 512. Then, in step 513, according to the next access request, the access operation will be performed. Apparently, if the inventive access method correctly predicts the next access request, the idle time for waiting the response of the operating system (e.g. the time needed from step 506 to step 509) can be therefore reduced. On the other hand, if the inventive access method fails to predict the next access request, it only needs quite short time to execute steps 511-513, which is relatively negligible compared to the time saved in the successful prediction.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment. Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

In conclusion, the inventive data access method and the inventive control system observe the uniformity and the continuity of the accesses requests and the corresponding memory addresses issued by the operating system. When the uniformity of the access requests and the continuity between the memory addresses are regular to a certain extent, the pre-accessing operation will be performed to improve the write/read performance of the data storage unit.

Those skilled in the art will readily observe that numerous modifications and alterations of the device and method may be made while retaining the teachings of the invention.

What is claimed is:

1. A data access method, comprising:
receiving a plurality of access requests and a plurality of corresponding addresses to access a plurality of data corresponding to the access requests from a storage unit; and
performing a pre-accessing operation upon the storage unit according to a uniformity of the access requests and a continuity between the addresses.

2. The data access method of claim 1, wherein the step of performing the pre-accessing operation upon the storage unit according to the uniformity of the access requests and the continuity between the addresses comprises:
when all the access requests correspond to a same type of access operation and the addresses are continuous, determining a specific address which is continuous with the addresses, and performing the pre-accessing operation according to the specific address.

3. The data access method of claim 2, wherein the step of performing a pre-access operation on the storage unit according to the uniformity of the requests and the continuity of the addresses comprises:
when all the access requests are read requests, performing a read operation according to the specific address to read a specific data corresponding to the specific address from the storage unit; and
temporarily storing the specific data; and
the data access method further comprising:
determining whether a specific read request corresponding to the specific address is received; and
directly outputting the specific data temporarily stored when the specific read request corresponding to the specific address is received.

4. The data access method of claim 2, wherein the step of performing the pre-accessing operation comprises:
when all the access requests are write requests, performing a preparing operation to configure the storage unit into a write ready state; and
the data access method further comprises:
determining whether a specific write request corresponding to the specific address is received; and
receiving a specific data corresponding to the specific write request, and writing the specific data into the storage unit in the write ready state according to the specific address when the specific write request corresponding to the specific address is received.

5. The data access method of claim 1, wherein the storage unit is a flash memory.

6. A control system, comprising:
a control circuit for accessing a storage unit;
a determination module, for receiving a plurality of access requests and a plurality of corresponding addresses to command the control circuit to access a plurality of data corresponding to the access requests from a storage unit and according to a uniformity of the access requests and the continuity between the addresses, to command the control circuit to perform a pre-accessing operation upon the storage unit.

7. The control system of claim 6, wherein when the determination module determines all the access requests correspond to a same type of access operation and the addresses are continuous, the determination module determines a specific address which is continuous with the addresses, and commands the control circuit to perform the pre-accessing operation according to the specific address.

8. The control system of claim 7, wherein when the determination module determines all the access requests are read requests, the determination module performs a read operation according to the specific address to read a specific data corresponding to the specific address from the storage unit, and the control circuit temporarily stores the specific data; and the determination module further determines whether a specific read request corresponding to the specific address is received; and the determination module commands the control circuit to directly output the specific data temporarily stored when the determination module determines the specific read request corresponding to the specific address is received.

9. The control system of claim 7, wherein when the determination module determines all the access requests are write requests, the determination module performs a preparing operation in order to configure the storage unit into a write ready state; the determination module further determines whether the specific write request corresponding to the specific address is received; and when the determination module determines the specific write request corresponding to the specific address is received, the determination module commands the control circuit to receive a specific data corresponding to the specific write request and to write the specific data into the storage unit in the write ready state according to the specific address.

10. The control system of claim 6, wherein the storage unit is a flash memory.
